(19) United States
(12) Patent Application Publication
(10) Pub. No.: US 2022/0361494 A1
(43) Pub. Date: Nov. 17, 2022

(54) AGRICULTURAL BIOSTIMULANTS INCLUDING SELECTED BRASSINOSTEROIDS AND TRIACONTANOL

(71) Applicants: Robert M. Hudak, Pompano Beach, FL (US); Tristan C. Hudak, Sacramento, CA (US); Robert M. Hudak, Pompano Beach, FL (US); Tristan C. Hudak, Sacramento, CA (US)

(72) Inventors: Robert M. Hudak, Pompano Beach, FL (US); Tristan C. Hudak, Sacramento, CA (US); Robert M. Hudak, Pompano Beach, FL (US); Tristan C. Hudak, Sacramento, CA (US)

(21) Appl. No.: 17/861,831

(22) Filed: Jul. 11, 2022

Related U.S. Application Data
(63) Continuation-in-part of application No. 17/585,075, filed on Jan. 26, 2022.
Application No. 17/585,075 is a continuation-in-part of application No. 17/164,434, filed on Feb. 1, 2021.
(60) Provisional application No. 62/968,569, filed on Jan. 31, 2020.

(51) Int. Cl. A01N 43/22; A01N 31/02

(52) U.S. Cl. CPC A01N 43/22; A01N 31/02

(57) ABSTRACT

A biostimulant concentrate includes purified water and a solubilizer, triacontanol, and an array of brassinosteroids selected from the group consisting of brassinolide, brassinone, dolicholide, homobrassinolide, and combinations thereof. The triacontanol is concentrated as a 95% concentrate that is included in an amount of 2-15 grains per liter of biostimulant concentrate. In one embodiment, 3 grams of triacontanol 95% is used per liter of biostimulant concentrate. The biostimulant is formulated into a foliar spray in one embodiment of the invention. The present inventive formulation is used as an in-furrow application, which is mixed with fertilizer in one aspect of the invention. The present invention is mixed with herbicide and broadcast sprayed in another embodiment of the invention. This broadcast spray can be performed either pre-emergence, or post emergence, or both.

### FIELD OF THE INVENTION

This invention relates to biostimulants used on agricultural soils and crops. More particularly, this invention relates to the manufacture and use of particular brassinosteroids.

### BACKGROUND OF THE INVENTION

Plant biostimulants are defined as those containing substance(s) and/or micro-organisms whose functions when applied to plants or soils are to stimulate natural plant growth processes. This can result from enhancing nutrient uptake, nutrient absorption efficiency, and improved tolerance to abiotic stresses.

The current global market size is over 2 Billion Dollars annually and is growing rapidly. The understanding in agriculture is that biostimulants bolster the strength of the crops to increase yield while minimizing the costs for fertilizers, pesticides, fungicides and herbicides.

Many biostimulants made from fermentation product suspensions are prone to settling. Agitation prior to use is common to assure consistency in dispersion and bio-effects.

Biostimulant suspensions derived from fermentation products are also prone to microbial contamination. In many cases, such biostimulant suspensions are pH adjusted to minimize microbial growth. pH adjustment is typically accomplished by mixing an acid such as citric acid, sulfuric acid, phosphoric acid, or potato wash, for examples with a buffer to make the fermentation product suspension.

With many pH adjusted fermentation product suspensions, the pH can change when the suspension is exposed to excessive heat and ambient air. Changes in pH can result in product destabilization, including change of color, odor, shrinking or swelling or bursting of the container, reduced efficacy, and other undesirable consequences of destabilization.

Biostimulants can be heavy and bulky and thus, costly to ship and store. This is due to high concentrations of water in the product.

Some biostimulants are produced by using yeast fermentation. Genetic drift and variation of substrate composition may alter the biostimulant fermentation products. This may impact the quality and efficacy of biostimulants produced from batch to batch, and over time.

There are many other biostimulants on the market, often consisting of humic acid or fulvic acid as the main constituents, often with the addition of macro or micro nutrients. Some use amino acids as the main active agents, and some have a combination of all of the above.

Vitazyme® is a fermented suspension including vitamins, enzymes, triacontanol, Brassinosteroids, and other growth stimulators. It is used successfully to enhance crop yields for a variety of crops. Brassinosteroids are in a concentration of 0.0022%-0.0059% and triacontanol is concentrated in the range of 0.012%-0.019%. The pH is adjusted and stabilized to between 3.5 and 4 by the addition of a strong acid to stabilize the formulation, and to inhibit microbial contamination. The recommended application rate is 13 oz/acre. The triacontanol to Brassinosteroid ratio in this prior art product is thus within the range of 5.45 to 3.22.

What is desired is a biostimulant that optimizes the triacontanol to Brassinosteroid ratio for optimal efficacy. What is also desired is a biostimulant that is concentrated for ease in storage, shipping and application and can be applied to crops with an application rate of less than 13 oz/acre. What is also desired is a biostimulant that can be produced with a consistency that exceeds the consistency demonstrated by traditional batch fermentation processes. What is further desired is a biostimulant that can be stabilized for improved shelf life without requiring the use of a strong acid. What is further desired is a biostimulant that, when applied to agricultural crops or soil, maximizes crop yield and quality.

### SUMMARY OF THE INVENTION

The present invention is an Emulsion in Water (EW) or Aqueous Solution formulated from Triacontanol 95% TC and Brassinolide 60-90% TC in one embodiment of the invention. TC means technical material and is a concentration determined on a weight to weight w:w basis. Triacontanol has a density of 0.777 g/ml at 95° C. Brassinolide has a density of 1.141 g/ml. While a 95% TC of Triacontanol is used, it can be appreciated that other concentrations may be used, and the volumes adjusted to achieve the same final product. Using a 95% TC of Triacontanol reduces the volume of the present invention to minimize weight, handling difficulty, storage volume requirements and shipping costs.

Triacontanol is a fatty alcohol that is also known as melissyl alcohol or myricyl alcohol. It can be derived from plant cuticle waxes and beeswax and other sources.

A non-ionic surfactant derived from sorbitan esters, such as Tween 80®, is a registered trademark of Croda Americas, Inc. The surfactant is used as an emulsifier and solubilizer. Tween 80® is also known as polyethylene glycol sorbitan monooleate. It has the chemical formula C₆₄H₁₂₄O₂₆. This surfactant is considered safe enough to use in human foods, and is often used in ice cream. Tween 80 and its analogues are important for enabling emulsification and concentration of the various elements of present invention.

Ethanol or other alcohol can also be used to optimize emulsification, particularly by enabling the incorporation of functional compounds that are not favorably soluble in either water or oil so that these functional compounds are emulsified effectively. In particular in order to achieve a desired concentration of Brassinosteroid, it must be mixed with ethanol or an analogue thereto.

Adjusting the pH to appropriate levels using citric acid, or other known additives, stabilizes the invention. Alternatively, nano silver and nano copper are used to preserve the present invention by inhibiting microbial growth, and thus being effective stabilizers where modifying the pH below 4.0 is not desirable. In any case, the invention can be diluted in-situ with water just prior to application so that the pH does not harm the particular crops and soils where it is applied. In this way undesired microbial growth is minimized by the short time between dilution of the invention and agricultural application.

Nano in this patent application means a particle sized between 1-100 nanometers in diameter. Thus, nano copper and nano silver include a sufficient amount of particles of each having a diameter within the range of 1-100 nm to have detectable or predictable anti-microbial effects in solution. Other stabilizers can be used instead of nano silver or copper. Where nano silver or nano copper are used, the pH is adjusted to between 5.5 and 6.4. In another embodiment of the invention, the pH is preferably adjusted to between 0.5 and 4.0 using citric acid. In many jurisdictions, the pH is adjusted through the addition of citric acid, or other non-toxic additive, to ease compliance with existing regulations.

Triacontanol increases chlorophyll content of the leaves of crops, increases CO₂ assimilation, and enhances photosynthesis. Through a number of mechanisms of action, Triacontanol triggers a cascade of metabolic events typically resulting in increased crop yield.

Brassinolide and other brassinosteroids promote stein elongation and cell division; promote vascular differentiation; protects plants during cold and drought stress; accelerates senescense; promotes resistance to salt stress; increases the metabolism of plants, and helps overcome pesticide toxicity.

The present inventive formulation is used as an in-furrow application, which is mixed with fertilizer in one aspect of the invention.

The present invention is mixed with herbicide and broadcast sprayed in another embodiment of the invention. This broadcast spray can be performed either pre-emergence, or post emergence, or both.

The broadcast spray can also be mixed with fungicides, insecticides, or fertilizers as a foliar spray; used as a foliar spray mixed with water; applied via drip or overhead irrigation, and used as a seed treatment. Combinations of such application methods can be optimized depending on the crop type, weather, and other factors.

An alternate embodiment of the formulation of the present invention is an in-furrow formulation having the benefits of increased uptake and bioavailability, increased vegetative growth for many plant species as well as improved resistance to pathogenic microbes, as well as pests including insects. This alternative embodiment has been analyzed to contain increased concentrations of Triacontanol and particular forms and concentrations of selected Brassinosteroids, including Brassinolide.

TABLE 1
(Examples of Selected Brassinosteroids)

| | | | | Specification |
|---|---|---|---|---|
| Analysis | Results | Units | Reference Methods | Range |
| 28-Norcastasterone (Brassinone) | 25.2 | ppm, w/w | ANACHEM-006-14-1¹ | — |
| Brassinolide (dolicholide) | 18.0 | ppm, w/w | ANACHEM-006-14-1¹ | — |
| 28-Homobrassinolide | 9.7 | ppm, w/w | ANACHEM-006-14-1¹ | — |
| Total Brassinosteroids | 52.9 | ppm, w/w | | 50 |
| 1-Triacontonal | 2,140 | ppm, w/w | GC/MS-SIM² | 2,000 |

TABLE 2
(Examples of Selected Brassinosteroids)

| Analysis | Results | Units | Reference Methods | Specification |
|---|---|---|---|---|
| 28-Norcastasterone (Brassinone) | 11.3 | ppm, w/w | ANACHEM-006-14-1¹ | — |
| Brassinolide (dolicholide) | 13.5 | ppm, w/w | ANACHEM-006-14-1¹ | — |
| 28-Homobrassinolide | 44.9 | ppm, w/w | ANACHEM-006-14-1¹ | — |
| Total Brassinosteroids | 69.7 | ppm, w/w | | 60 |
| 1-Triacontonal | 3,610 | ppm, w/w | GC/MS-SIM² | 3,000 |

Analytical Methods used for Table 1 and Table 2:
1 Cornerstone Procedure ANACHEM-006-14-1-Brassinolide Related Steroid Analysis by Gas Chromatography with Mass Spectroscopy Detection, 1/20/17.
2 GA3 Reference Method: Plant Growth Regulation #28 (1999) 21-27 Modified using GC/MS-SIM

Brassinosteroids are a class of polyhydroxysteroids that are recognized as a sixth class of plant hormones. While brassinolide was first isolated and defined in the late 1970's, many other brassinosteroids have been identified, and isolated since then.

The total brassinosteroids in the formulation of the present invention as expressed in Table 1 and Table 2 are within the range of 52.9 and 69.7 ppm in the formulation and are particularly balanced to enhance plant growth and maximize disease resistance.

Importantly the particular brassinosteroids are selected for optimal function of the present invention in enhancing vegetative growth and harvest yield. In one embodiment of the invention, an optimal combination of brassinosteroids is expressed in Table 2, and include 28-Norcastasterone (Brassinone), Brassinolide (Dolicholide), and 28-Homobrassinolide.

Homobrassinolide has a chemical formula of C₂₉H₅₀O₆. In the present invention, the amount of Homobrassinolide, in terms of ppm, can vary by +/−25% on a w:w basis.

Brassinolide (dolicholide) has a chemical formula of C₂₈H₄₆O₆. In the present invention, the amount of Brassinolide (dolicholide), in terms of ppm, can vary by +/−25% on a w:w basis.

Brassinone has a chemical formula of C₂₇H₄₆O₅. In the present invention, the amount of Brassinone, in terms of ppm, can vary by +/−25% on a w:w basis.

In one embodiment the ratio of triacontanol to total brassinosteroids is between 40:1 and 50:1.

It can be appreciated that the relative ratios of the various brassinosteroids can be engineered to vary in concentrations with respect to each other to optimize particular agricultural crop production yields and vegetative growth, depending on climate, soils and other factors.

### BRIEF DESCRIPTION OF THE DRAWINGS

FIG. 1 is a flow chart of a method of manufacturing the present invention.

### DETAILED DESCRIPTION

The biostimulant of present invention is a stable solution or emulsion and its constituents resist settling even after great periods of time and over varied temperature ranges. The solution is concentrated for easy transportation and storage. In one preferred embodiment, the biostimulant is a concentrate including purified water, triacontanol, at least one brassinosteroid selected from the group consisting of brassinolide, brassinone, dolicholide, and homobrassinolide. The ratio of triacontanol to at least one brassinosteroid is between 40:1 and 50:1 on a w:w basis.

In a variation of this embodiment the at least one brassinosteroid includes each of: brassinolide, brassinone, dolicholide, and homobrassinolide.

In another embodiment, at least one brassinosteroid includes only brassinolide, only brassinone, only dolicholide, or only homobrassinolide. In a variation of this embodiment, no more than two brassinosteroids comprise the total brassinosteroid concentration.

In another preferred embodiment, the biostimulant contains at least 0.003% (preferably between 0.006% and 0.0162%) Brassinosteroid and at least 0.2% (preferably between 0.2-0.5%) triacontanol. More preferably, a concentration of 0.3% triacontanol is used. In one embodiment of the invention the Bio Shot products contains 3000 parts per million (ppm) of Triacontanol, derived from Triacontanol 20% TC to 95% TC. With the 95% TC triacontanol variant of the invention, the triacontanol 95% TC is in a concentration of 2-15 grains per liter of biostimulant concentrate.

The present invention perfects the steps of achieving solubility and long term shelf stability of these active ingredients.

The solution is stable, milky white in appearance, and will not expand or burst its container under ambient conditions.

The brassinolide is a plant growth hormone having the chemical formula C₂₈H₄₈O₆. It is preferably extracted from rape seed pollen, is analyzed by High Pressure Mass Spectrometry to determine purity, and then mixed with ethanol to produce a water soluble solution.

The triacontanol is a plant growth stimulant having the chemical formula C₃₀H₆₂O. The triacontanol is preferably derived from rice bran wax and formulated to 20% TC, as used herein, means the technical product concentration, where the percentage is a weight to volume ratio as measured in grams per liter. For example 15 gms of triacontanol having a TC of 20% equals 3 grains per liter, which is approximately 3000 parts per million (ppm) when made water soluble by mixing with Tween 80 in heated water.

The present inventive solution, in one embodiment, contains as much, or more, of brassinosteroids including brassinolide and 25 times more triacontanol than the product described above known as Vitazyme®, depending on the batch of Vitazyme® tested. One advantage of concentration is that shipping costs are reduced, storage space is minimized and preservative volume requirements are reduced.

Preferably the ratio of triacontanol to total brassinosteroids in the present invention is between 40:1 and 50:1. In various embodiments this ratio can more broadly be implemented as between 30:1 to 60:1, or any ratio between. In more specific embodiments the ratio can be approximately 45:1. The ideal ratio may vary depending on application method.

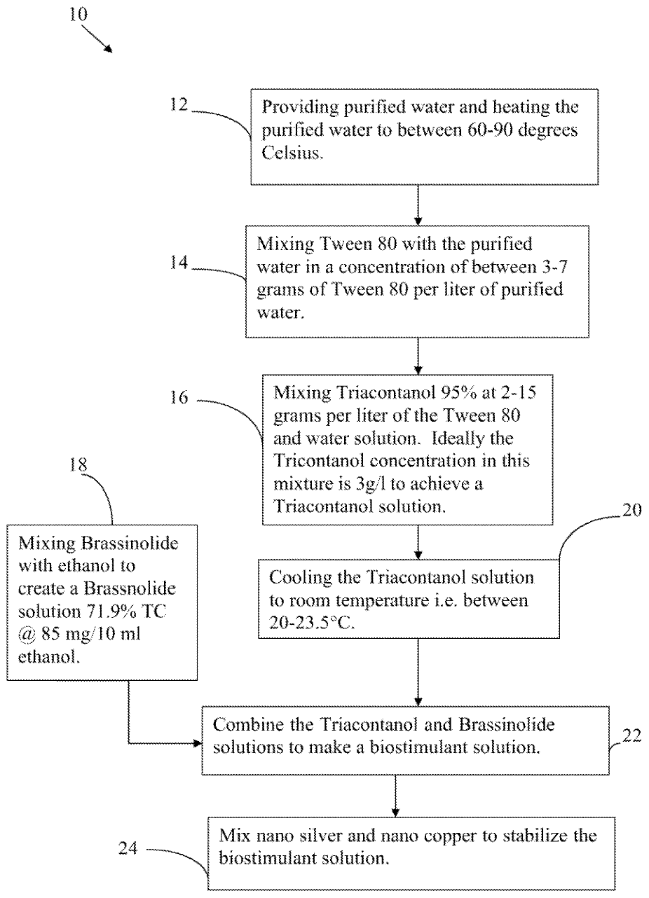

FIG. 1 is a flow chart of a method in accordance with the present invention, generally designated with the reference numeral 10.

The method 10 includes the step 12 of providing purified water and heating the purified water to between 60-90 degrees Celsius at ambient pressure. The purified water can be distilled or reverse osmosis filtered. In a preferred embodiment, the temperature is 85° C. +/−1° C. to optimize solubility of the active components in subsequent steps. In another embodiment the temperature range is 80° C. +/−10° C. Normally the temperature will not exceed 100° C.

The method 10 includes the step 14 of mixing Tween 80 (C₆₄H₁₂₄O₂₆) with the purified water in a concentration of between 3-7 grains of Tween 80 per liter of purified water. In a preferred embodiment the concentration in grams per liter of the Tween 80 and the purified water is 5 grams per liter +/−1 gram. This yields a Tween and water solution.

The method 10 further includes the step 16 of mixing Triacontanol 95% at 2-15 grams per liter of the Tween 80 and water solution. Ideally, in an alternate embodiment, the triacontanol 95% concentration in this mixture is 15 grams per liter +/−1 gram to yield an optimized triacontanol solution.

The step 18 includes cooling the triacontanol solution to room temperature i.e. between 20-23.5° C. +/−5° C. to enable the optimal addition of brassinosteroids. Preferably any brassinosteroid used is in an ethanol solution to optimize solubility. The ethanol solution enables the desired concentrations of Brassinosteroid to be achieved in step 22 where the Triacontanol and brassinosteroid solutions are mixed to achieve a biostimulant solution. Here, the brassinosteroid, brassinolide is used as an example.

In an alternate embodiment, the step 18 includes adding an array of brassinosteroids selected for optimal function of the present invention in enhancing vegetative growth and harvest yield. In this embodiment of the invention, an optimal combination of brassinosteroids is expressed in Table 2, and include 28-Norcastasterone (Brassinone), Brassinolide (Dolicholide), and 28-Homobrassinolide.

The step 24 includes mixing nano silver and nano copper to stabilize biostimulant solution and inhibit microbial growth. Alternatively, the step 24 can utilize effective amounts of citric acid (such as 0.5 grains) to achieve a desired pH, which inhibits microbial growth. A further alternative includes utilizing both citric acid and nano copper or other suitable metal to stabilize the invention.

One advantage of using citric acid in step 24 is that this ingredient is compliant with most regulatory frameworks worldwide, and is relatively cost effective. An advantage of using the alternative i.e. nano copper or other metal, is that it may function as a trace element to bolster the resulting crop nutritional profile in humans.

This method can be performed in a clean room that enables a maximum of 10,000 particles greater than 0.5 μm per cubic feet of volume to minimize microbial contamination of the biostimulant solution.

In various examples, the present invention and methods of application thereof can benefit agricultural yields for a variety of crops including grains, tubers, maize, and legumes including peanuts, and soybeans. The present invention has also been tested successfully with cruciferous vegetables, nightshades, and tree fruit including cabbage, apples and tomatoes.

It can be appreciated that the present invention is also useful for most agricultural crops. This is a significant benefit of having the present invention, as it can be used for most commercial crops. This makes storage and transportation more efficient for the user.

One method of synthesizing nano-copper (copper nanoparticles having a diameter of between 1-100 nanometers) involves the copper (II) hydrazine carboxylate salt which undergoes a radical reaction with radical hydrogen produced by ultrasounds to form nanoparticles, hydrogen peroxide, and hydrazine carboxylic acid.

A method of synthesizing nano-silver (silver nanoparticles having a diameter of between 1-100 nanometers) includes citrate reduction, reduction via sodium borohydride, monosaccharide reduction as well as the polyol process.

Biological synthesis has also been used to make agricultural-ready nano-silver. This includes the biological synthesis of nanoparticles without requiring the use of reducing agents like sodium borohydride, and to limit the tendency of the nanoparticles to aggregate.

A variety of other stabilizers in addition to silver and copper or other metal can be used. It can be appreciated that although the present invention is described in terms of using brassinosteroids in many embodiments, any of a variety of brassinosteroids can be substituted, including those described herein in particular concentrations, and others, and other novel concentrations to optimize biomass growth, crop yield per acre, nutrient density, visual attributes, fruit or vegetable sizes, and other attributes.

I claim:

1. A biostimulant concentrate comprising:
purified water and a solubilizer;
triacontanol 95% in a concentration of 2-15 grains per liter of the biostimulant concentrate;
at least one brassinosteroid, yielding a total brassinosteroid concentration of between 40-70 ppm in the biostimulant concentrate;
the at least one brassinosteroid includes homobrassinolide having the chemical formula C₂₉H₅₀O₆, in a concentration of at least 9.7 ppm in the biostimulant concentrate; and
a stabilizer.

2. The biostimulant concentrate as set forth in claim 1, wherein the at least one brassinosteroid includes brassinolide, having the chemical formula C₂₈H₄₈O₆.

3. The biostimulant concentrate as set forth in claim 1, wherein the at least one brassinosteroid includes dolicholide, having chemical formula C₂₈H₄₆O₆.

4. The biostimulant concentrate as set forth in claim 1, wherein the at least one brassinosteroid includes brassinone, having chemical formula C₂₇H₄₆O₅.

5. The biostimulant concentrate as set forth in claim 1, wherein at least one brassinosteroid is selected from the group consisting of brassinolide, brassinone, dolicholide, homobrassinolide, and combinations thereof.

6. The biostimulant concentrate as set forth in claim 1, wherein the at least one brassinosteroid is selected from the group consisting essentially of brassinolide, brassinone, dolicholide, homobrassinolide, and combinations thereof.

7. The biostimulant concentrate as set forth in claim 1, further comprising citric acid to maintain the pH of the biostimulant is between 3.5 and 4.0.

8. The biostimulant concentrate as set forth in claim 1, further comprising citric acid to maintain the pH of the biostimulant between 3.0 and 3.5.

9. A biostimulant concentrate comprising:
purified water and a solubilizer;
triacontanol 95% in a concentration of 2-15 grains per liter of the biostimulant concentrate;
an array of brassinosteroids selected from the group consisting of brassinolide, brassinone, dolicholide, homobrassinolide, and combinations thereof, and
the ratio of the triacontanol to the array of brassinosteroids is between 40:1 to 50:1 on a w:w basis.

10. The biostimulant concentrate as set forth in claim 9, wherein the array of brassinosteroid concentration is between 40-70 mg/l or ppm.

11. The biostimulant concentrate as set forth in claim 9, wherein the triacontanol concentration is approximately 3000 mg/l or ppm.

12. The biostimulant concentrate as set forth in claim 9, wherein the ratio of triacontanol to the array of brassinosteroids is between 40:1 to 50:1 on a w:w basis.

13. The biostimulant concentrate as set forth in claim 9, wherein the brassinosteroids are selected from the group consisting essentially of brassinolide, brassinone, dolicholide, and homobrassinolide.

14. A biostimulant concentrate comprising:
purified water;
triacontanol 95% in a concentration of 2-15 grains per liter of the biostimulant concentrate;
at least one brassinosteroid selected from the group consisting essentially of brassinolide, brassinone, dolicholide, and homobrassinolide, and
the ratio of triacontanol to at least one brassinosteroid is between 40:1 and 50:1 on a w:w basis.

15. The biostimulant as set forth in claim 14, wherein the at least one brassinosteroid includes each of: brassinolide, brassinone, dolicholide, and homobrassinolide.

16. The biostimulant as set forth in claim 14, wherein the at least one brassinosteroid comprises only brassinolide.

17. The biostimulant as set forth in claim 14, wherein the at least one brassinosteroid comprises only brassinone.

18. The biostimulant as set forth in claim 14, wherein at least one brassinosteroid comprises only dolicholide.

19. The biostimulant as set forth in claim 14, wherein at least one brassinosteroid comprises only homobrassinolide.

20. The biostimulant as set forth in claim 14, wherein at least one brassinosteroid comprises no more than two brassinosteroids.
